(19) United States
(12) Patent Application Publication
(10) Pub. No.: US 2006/0070412 A1
(43) Pub. Date: Apr. 6, 2006

(54) Non-register cash drawer with a keypad control

(76) Inventor: Brian M. Wiseman, Saugus, MA (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 11/244,129

(22) Filed: Oct. 5, 2005

Related U.S. Application Data
(60) Provisional application No. 60/615,971, filed on Oct. 5, 2004.

(51) Int. Cl. E05B 65/46

(52) U.S. Cl. 70/88

(57) ABSTRACT

A cash drawer suitable for use in an applications where point of sale information is not recorded, such as at hotel front-desks, athletic health clubs, schools, and the like. The cash drawer includes an electronic keypad having one or more access codes used to control access to the cash drawer. The keypad can be reprogrammed easily to change access rights.

### RELATED APPLICATIONS

This application claims priority under 35 U.S.C. § 119(e) to U.S. Provisional Application Ser. No. 60/615,971, filed on Oct. 5, 2004, which is hereby incorporated by reference in its entirety.

### BACKGROUND OF INVENTION

1. Field of the Invention

This invention relates to an electric, programmable, manually operated, combination-keypad controlled cash drawer.

2. Description of Related Art

Employees of commercial establishments often collect cash and checks as well as dispense cash with their customers using a cash drawer. There are two common applications for such cash drawers. The first application includes a manually operated cash drawer, typically used where there is no sale of services or goods, such as at hotel front-desks, athletic health clubs, schools, and the like. The second application includes a point of sale (POS) transaction involving the sale of goods or services, as is found in stores. In the later application, the cash drawer is often associated with a device that both records/registers the transaction and controls access to the cash drawer when goods or services are sold. The Applicant appreciates that a separate device to record transactions is not required in the first type of application and may be undesirable by adding unnecessary cost and/or by consuming needed space.

Aspects of the present invention provide an improved device for controlling access to a cash drawer for particular use in applications where point of sale transactions are not recorded. Such “non-register” cash drawers may be manually opened and closed and may have the capability of being locked closed with a mechanical lock. Cash drawers without any locking features are subject to common theft. If the cash drawer has a mechanical lock with a tumbler-key locking feature and the key is lost or stolen, the proprietor must re-key the lock, a burdensome task, in order to lock or open the cash drawer. If the cash drawer has a mechanical lock with a combination type lock, the proprietor may need to change the combination every time an employee leaves his company, also a burdensome task.

### SUMMARY OF INVENTION

Aspects of this invention overcome problems of the prior art associated with non-register cash drawers that either lack locking mechanisms or that have only key-lock or combination lock arrangements.

According to one aspect of the invention, a non-register cash drawer is disclosed that comprises a housing and a drawer slideably movable with respect to the housing between an open position where access is provided to the drawer and a closed position where access to the drawer is prevented. An electronically actuated lock that has a locked position and a release position is included in the cash drawer. The drawer is prevented from moving from the closed position to the open position when the electronic lock is in the locked position and the drawer is allowed to move from the closed position to the open position when the electronic lock is in the release position. The non-register cash drawer also includes an electronic keypad located remote from the housing and that stores an access code. The electronic keypad provides a control signal to the electronic lock to move the electronic lock from the locked position to the release position when a user enters the access code into the electronic keypad. The electronic keypad is also adapted to be reprogrammed to change the access code.

According to another embodiment, the non-register cash drawer also includes a manually actuated lock having a first manual lock position, a second manual lock position, and a third manual lock position. When the manually actuated lock is in the first manual lock position, the cash drawer is prevented from moving from the closed position to the open position whether the electronic lock is in the locked or the release position. When the manual lock is in the second manual lock position and the electronic lock is in the locked position, the cash drawer is prevented from moving from the closed position to the open position. When the manual lock is in the second manual lock position and the electronic lock is in the release position, the cash drawer is allowed to move from the closed position to the open position. When the manual lock is in the third manual lock position, the cash drawer is allowed to move from the closed position to the open position whether the electronic lock is in the locked or the release position. The non-register cash drawer also includes a first spring element positioned inside the housing that is adapted to bias the drawer toward the open position and a second spring element biasing the electronic lock toward the locked position. A cable connects the electronic keypad to the electronically actuated lock. The cable is adapted to deliver a voltage from the keypad to the electronically actuated lock to move the electronically actuated lock from the first electronic position to the second electronic position when the access code is entered into the keypad.

Various embodiments of the present invention provide certain advantages. Not all embodiments of the invention share the same advantages and those that do, may not share them under all circumstances. Further features and advantages of the present invention, as well as the structure of various embodiments of the present invention are described in detail below with reference to the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of components of a non-register cash drawer, according to one embodiment of the invention.

FIG. 2 is a cutaway view of components of the non-register cash drawer shown in FIG. 1.

### DETAILED DESCRIPTION

The apparatus of the present invention is adapted to control access to a lock box, such as a cash drawer, without also requiring a mechanism to record point of sale transactions. Such an apparatus may be ideal for use where cash is collected and/or dispensed without also recording the sale of goods or services, such as at hotel front-desks, athletic health clubs, schools, and the like.

As used herein, the term “non-register cash drawer” refers to a cash drawer that selectively allows an operator access to contents of the cash drawer without also including components to automatically record or register transactions, as is commonly found in point of sale or “register” cash drawers. The term “non-register cash drawer” is used interchangeably with the term “non-register cash drawer with keypad control” and the term “cash drawer”. As used herein, the term “electronic lock” is used interchangeably with the term “electronically actuated lock”. The term “manual lock” is used interchangeably with the term “manually actuated lock”. The term “keypad” is interchangeable with the term “electronic keypad” and the term “remote keypad”.

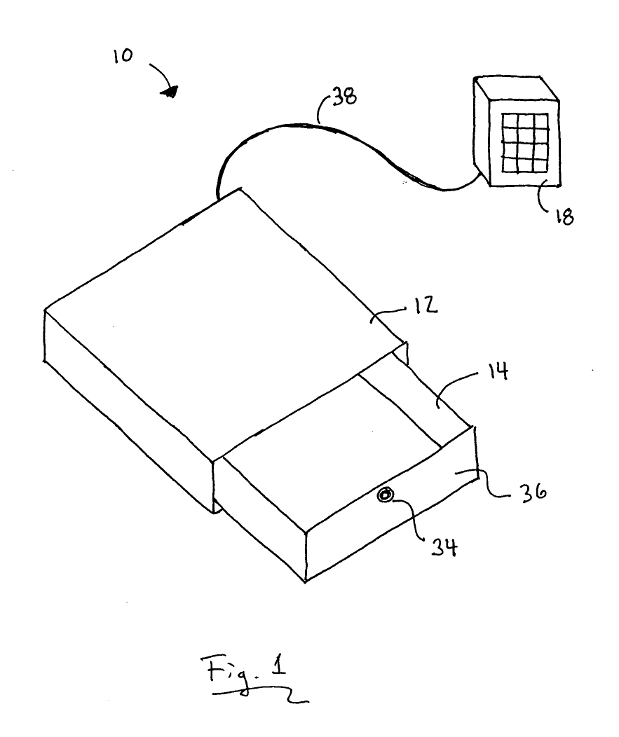

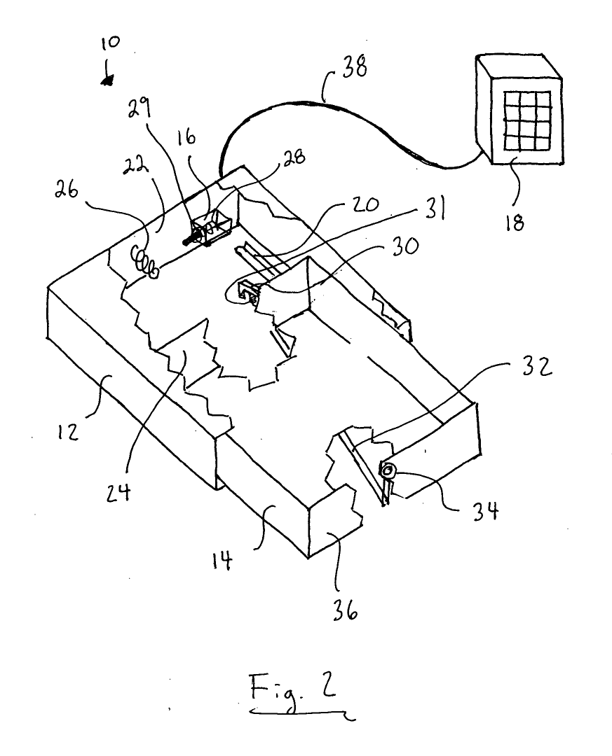

Turn now to FIGS. 1 and 2 where components of a non-register cash drawer are shown according to one embodiment of the invention. As illustrated, the non-register cash drawer 10 includes a housing 12 that slideably receives a drawer 14. The drawer can move between a closed position, where the contents of the drawer may not be accessed, and an open position where a operator can freely access contents of the drawer. An electronically actuated lock 16 is incorporated into the housing and can hold the drawer in the closed position or release the cash drawer from the closed position such that it can move to the open position. The non-register cash drawer also includes a remote, electronic keypad 18 that actuates the electronic lock 16. The keypad stores one or more access codes that, when provided to the keypad, causes the electronically actuated lock to move from a locked position to a release position to allow the drawer to be moved from the closed position to the open position.

The housing, in one illustrative embodiment of the invention, is constructed of sheet metal formed into a box-like shape. As shown in FIGS. 1 and 2, the box can be substantially rectangular and can have preferred dimensions of 16″×16″×4″, although other shapes and sizes are possible as aspects of the invention are not limited in this regard. The illustrated housing includes a pair of sliding bearings 20 that connect the housing to the drawer and allow the drawer to slideably move between the closed and the open position. The slide bearings can be removably fastened to the housing and/or the drawer to allow the housing and drawer to be separated from one another as needed for servicing or cleaning. Preferably, features that facilitate detachment of the drawer from the housing may only be accessed when the drawer is in the open position to prevent theft of cash drawer contents or damage to the cash drawer itself. In the illustrated embodiment, the drawer is just slightly smaller in size than the housing, which maximizes the space available for holding contents in the drawer. However, in some embodiments, the cash drawer may be substantially smaller to provide extra room for internal components of the non-register cash drawer, such as latches, solenoids, power sources, and the like.

As illustrated in the embodiment of FIGS. 1 and 2, the electronic lock comprises a solenoid 29 that interfaces with a latch 30 to hold the drawer in the closed position. The electronic lock includes a solenoid return spring 28 that returns the electronic lock to the locked position when the solenoid is not actuated. However, it is to be appreciated that not all electronic locks will have a solenoid or a solenoid return spring, as the invention is not limited in this manner.

Embodiments of the cash drawer have features that facilitate efficient operation by an operator. As shown in the embodiment of FIG. 2, a spring element 26 can be positioned between a back wall 22 of the housing and a back wall 24 of the drawer. The spring element acts to bias the drawer towards to the open position. In this manner, an operator is not required to pull the drawer open when the drawer is free to move from the closed position, such as when the drawer is released by the electronic lock. However, it is to be appreciated that not all non-register cash drawers require such a spring element, as the present invention is not limited in this regard.

In one embodiment, the electronic lock is biased toward the locked position to promote efficient use of the cash drawer. After the electronic lock is moved to the release position, the drawer is moved to the open position, a spring element 31 moves a latch 30 in the electronic lock to the locked position such that once the drawer is returned to the closed position the latch will hold the drawer closed. In this sense, the operator can close and lock the drawer in a single motion. Some embodiments may include a ramp feature on the latch to facilitate such an ‘auto lock’ feature. The ramp causes the latch of the electronic lock to move out of the way against the force of the spring as the drawer slides into the closed position. Once in the closed position, the spring element of the latch moves the electronic lock back into the locked position.

Cash drawers according to various embodiments of the invention can have additional features to provide added security. As shown in FIG. 2, the electronic lock can be positioned between a back wall of the housing and back wall of the cash drawer. In this regard, the electronic lock is position away from access points of the cash drawer to prevent tampering with the electronic lock.

In one illustrated embodiment, the non-register cash drawer includes a manually actuated lock 34 in addition to the electronically actuated lock 16. The manual lock 34 may be placed anywhere on the cash drawer but preferably is placed on a front face 36 of the drawer where it is readily accessible by an operator. The manual lock can be actuated by a key that can move the lock between a locked position, an open position, and/or and an unlocked position.

When the manual lock is in the open position, the drawer is allowed to slide freely between the closed and open positions, regardless of the position of the electronic lock. In this sense the open position of the manual lock may be considered a “master opened” position. The open position of the manual lock can be used to open the cash drawer in the event of a malfunction of the keypad or the electronic lock or if all operators have lost their access codes. As shown in FIG. 2, the manually actuated lock can be connected to the electronic lock by a connector bar 32 that facilitates moving the latch 30 to the unlocked position when the manual lock is in the open position. It is to be appreciated that not all manual locks have an open position or a connector bar, as the present invention is not limited in this regard.

In the locked position, the manually actuated lock prevents the drawer from moving from the closed position to the open position, regardless of the position the electronically actuated lock. In this sense, the locked position of the manual lock may be considered a “master locked” position. The locked position can be used to prevent operators from accessing the cash drawer even if they have a valid access code. A connector bar, like that shown in FIG. 2, can be used to connect the manual lock to the latching mechanism of the electronic lock such that the electronic lock can be moved to the locked position along with the manual lock. It is to be appreciated that not all embodiments of the invention require a connector bar or a manually actuated lock with a locked position as the invention is not limited in this respect.

In the unlocked position, the manually actuated lock allows the electronically actuated lock to determine whether the drawer can move from the closed position to the open position. During normal operation, the manually actuated lock will be placed in the unlocked or “operation position” such that the keypad and electronic lock can be used to provide or deny access to the contents of the cash drawer.

In one illustrative embodiments of the invention, the manually actuated lock includes an open position, an unlocked position, and a locked position. In another embodiment, the manual lock includes an open position and an unlocked position. In yet another embodiment, the manual lock includes an unlocked position and a locked position, as the invention is not limited to any particular combination of manual lock positions, or to having a manual lock at all.

As shown in FIG. 1, embodiments of the invention include a remotely located keypad 18 that actuates the electronic lock. As shown, the electronic keypad can include a 12-digit keypad like that found on a typical telephone. The keypad can have one or more stored access codes that, when entered into the keypad, cause the electronic lock to move to the release position, thus allowing the drawer to move from the closed position to the open position.

The remote keypad can be positioned differently as may be required for specific applications. By way of example, the remote keypad can be located where it is hidden from the view of customers or patrons of a gym or hotel so that the patrons will not witness the entry of access codes into the keypad. In other embodiments, the keypad may be provided where it is accessible to patrons such so they may enter access codes themselves. In some embodiments, the remote keypad may be located adjacent or even on top of the cash drawer for convenient access while in other embodiments the cash drawer and the keypad can be located in different rooms, as aspects of the invention are not limited in this regard.

The electronic keypad can release the electronic lock in different ways. In one embodiment, a cable 38 capable of carrying low voltage current connects the keypad to the electronic lock in the housing. When a correct access code is entered into the keypad, a low voltage current is provided to the electronic lock, which in turn, moves the electronic lock to the release position. The cable can be securely routed between the keypad and housing to prevent tampering by thieves or vandals. It is to be appreciated that, in other embodiments the keypad can communicate with the electronic lock in different ways, such as by wireless communication, or through other means, as aspects of the invention are not limited in this regard.

Power can be provided to the keypad and the electronic lock in different ways. In one embodiment, the keypad receives power from a standard 120 volt AC wall socket. In another embodiment, the power supply is any other AC or DC voltage, other than 120 volt AC, as aspects of the invention are not limited in this regard. In other embodiments, the keypad may be directly wired into the electrical system of a building to prevent tampering or inadvertent interruption of power. In some embodiments, the electronic keypad includes a secondary battery source such that power is not interrupted to the keypad if power in the building is interrupted. In other embodiments, the keypad has internal batteries that act as the sole power source to the keypad.

The electronic lock may receive power solely from the cable that connects the electronic lock to the keypad. In such embodiments, voltage provided along the cable actuates a spring loaded solenoid in the electronic lock to move the lock to the release position. Upon removal of the voltage, the spring in the solenoid will return the solenoid and the latch of the electronic lock to the locked position. In another embodiment, an electronic lock may be adapted to receive a data signal that causes the lock to move to the release position under power provided by a battery within the housing of the cash drawer or by an electrical connection to the housing from another source.

The keypad may be reprogrammed to replace or add access codes as needed by a operator. In this sense, the keypad may be able to retain a single access code to provide access to the cash drawer or multiple different access codes such that multiple, different access codes can be provided to different operators. Illustrative embodiments can store more than 10 access codes, more than 50 access codes, more than 100 access codes, or even a greater number of access codes. The access codes can be added or removed from the keypad to control which employees or other types of operators have access to the cash drawer.

In one embodiment, when an incorrect access code is entered into the keypad two or more times, the keypad prevents the electronic lock from moving to the release position for a period of time. The period of time may be up to 30 seconds, 1 minute, 5 minutes, or until a correct access code is entered. In this regard, tampering with the keypad and the cash drawer can be minimized. The access codes can be of any length and may include numbers and letters or other features depicted on the keypad.

This invention is not limited in its application to the details of construction and the arrangement of components set forth in the above description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A non-register cash drawer with keypad control comprising;
a housing;
a drawer slideably movable with respect to the housing between an open position where access is provided to the drawer and a closed position where access to the drawer is prevented;
an electronically actuated lock having a locked position and a release position, wherein the drawer is prevented from moving from the closed position to the open position when the electronically actuated lock is in the locked position, further wherein the drawer is allowed to move from the closed position to the open position when the electronically actuated lock is in the release position; and
an electronic keypad located remote from the housing and storing an access code, wherein the electronic keypad provides a control signal to the electronically actuated lock to move the electronically actuated lock from the locked position to the release position when a user enters the access code into the electronic keypad, further wherein the electronic keypad is adapted to be reprogrammed to change the access code.

2. The non-register cash drawer with keypad control of claim 1, wherein the electronic keypad is adapted to store multiple access codes.

3. The non-register cash drawer with keypad control of claim 1, wherein upon an incorrect access code being entered into the electronic keypad multiple times, the electronic keypad prevents the electronically actuated lock from being moved from the locked position to the release position for a period of time.

4. The non-register cash drawer with keypad control of claim 3, wherein the period of time is greater than one minute.

5. The non-register cash drawer with keypad control of claim 1, further comprising:
a cable that connects the electronic keypad to the electronically actuated lock, the cable adapted to deliver a voltage from the electronic keypad to the electronically actuated lock to move the electronically actuated lock from the locked position to the release position when the access code is entered into the electronic keypad.

6. The non-register cash drawer with keypad control of claim 1, wherein the electronically actuated lock includes a solenoid that moves the electronically actuated lock between the locked position and the release position.

7. The non-register cash drawer with keypad control of claim 6, further comprising:
a spring element biasing the electronically actuated lock toward the locked position.

8. The non-register cash drawer with keypad control of claim 1, further comprising:
a spring element positioned inside the housing and adapted to bias the drawer toward the open position.

9. A non-register cash drawer with keypad control comprising;
a housing;
a drawer slideably movable with respect to the housing between an open position where access is provided to the drawer and to a closed position where access to the drawer is prevented;
an electronically actuated lock having a locked position and a release position, wherein the drawer is prevented from moving from the closed position to the open position when the electronically actuated lock is in the locked position, further wherein the drawer is allowed to move from the closed position to the open position when the electronically actuated lock is in the release position;
a first spring element positioned inside the housing and adapted to bias the drawer toward the open position;
a manually actuated lock having a first manual lock position, a second manual lock position, and a third manual lock position, wherein when the manually actuated lock is in the first manual lock position, the drawer is prevented from moving from the closed position to the open position whether the electronically actuated lock is in the locked or the release position, wherein when the manually actuated lock is in the second manual lock position and the electronically actuated lock is in the locked position, the drawer is prevented from moving from the closed position to the open position, wherein when the manually actuated lock is in the second manual lock position and the electronically actuated lock is in the release position, the drawer is allowed to move from the closed position to the open position, wherein when the manually actuated lock is in the third manual lock position, the drawer is allowed to move from the closed position to the open position whether the electronically actuated lock is in the locked or the release position;
an electronic keypad located remote from the housing and storing an access code, wherein the electronic keypad provides a control signal to the electronically actuated lock to move the electronically actuated lock from the locked position to the release position when a user enters the access code into the electronic keypad, further wherein the electronic keypad is adapted to be reprogrammed to change the access code;
a second spring element biasing the electronically actuated lock toward the locked position; and
a cable that connects the electronic keypad to the electronically actuated lock, the cable adapted to deliver a voltage from the electronic keypad to the electronically actuated lock to move the electronically actuated lock from the first electronic position to the second electronic position when the access code is entered into the electronic keypad.

10. The non-register cash drawer with keypad control of claim 9, wherein the electronic keypad is adapted to store multiple access codes.

11. The non-register cash drawer with keypad control of claim 9, wherein upon an incorrect access code being entered into the electronic keypad multiple times, the electronic keypad prevents the electronically actuated lock from being moved from the locked position to the release position for a period of time.

12. The non-register cash drawer with keypad control of claim 11, wherein the period of time is greater than one minute.

13. The non-register cash drawer with keypad control of claim 9, wherein the electronically actuated lock includes a solenoid that moves the electronically actuated lock between the locked position and the release position.
